(19) United States
(12) Patent Application Publication
(10) Pub. No.: US 2017/0216634 A1
(43) Pub. Date: Aug. 3, 2017

(54) Nose Respiratory Filtration Mask

(71) Applicant: Minghua Wan, Lombard, IL (US)

(72) Inventor: Minghua Wan, Lombard, IL (US)

(21) Appl. No.: 15/012,326

(22) Filed: Feb. 1, 2016

(51) Int. Cl. A62B 23/06; A62B 7/10

(52) U.S. Cl. CPC A62B 23/06; A62B 7/10

(57) ABSTRACT

A nose respiratory filtration mask or a nasal infiltration device is invented. It includes a master piece for its mounting, supporting, and sealing purposes, and a high efficiency nanofiber filter that is mounted outside the nostrils on the master piece. This invention of a nose respiratory filtration mask fills the gaps between face masks and nasal filters. It has the advantages of both face masks for their high filtration efficiency and nasal filters for their tight sealing. It is comfortable to wear with excellent respiratory protection as well as aesthetic appearance.

### CROSS-REFERENCE TO RELATED APPLICATIONS

This application is to convert the Provisional Utility Patent Application No. 62/273,922 filed on Dec. 31, 2015 to non-Provisional Utility Patent.

### BACKGROUND

Air pollution, such as smog, carries high concentrations of particulate matter (PM) including heavy metals, toxic chemicals, volatile organic compounds, bacteria, and viruses. These pollutants typically originate from industrial activities, coal burning, automobile exhausts, and other pollution sources. Particulates are the deadliest form of air pollution due to their ability to penetrate deep into the lungs and blood stream if they are not filtered from one's breathing, causing permanent DNA mutations, heart attacks, respiratory diseases, cancer, and premature death. Commonly available personal respiratory protection devices include face masks and nasal filters. Most of the face masks on the market are not designed for particulate pollutant protection. Only a few brands of face masks claim to have filtration rates of 95% or higher for small particles such as PM2.5 (particulate matter with diameters less than 2.5 micron), from smog sources. Because of the difficulty to seal, polluted air leakage into the face masks through the gaps between the masks and the user's face is a major drawback for this type of respiratory protection devices. In addition, their bulk and aesthetics limit their day to day wearing.

Nostril filters or nasal filtration devices are another category of personal respiratory protection devices in the market. Nasal filtration devices generally contain filters mounted on their nostril rings that are designed to prevent leakage of the polluted air from the side walls of the rings when they are properly inserted into the nostrils. The filtration materials may contain fibers made of fiberglass, metals, ceramics or polymeric compositions. Because of the small filter surface areas confined by the nostril cavities, nostril filters typically use larger pore-size filters to avoid the difficulty of breathing due to the limited air flow passage. These large pore-size filters are typically ineffective in filtering fine particulates such as PM2.5. Even though some non-woven micron sized fibers, such as HEPA (high-efficiency particulate air) filters, are used in some nostril filters, the strong restriction of air flow across the filter makes them uncomfortable to users.

To overcome the shortcomings of air leakages from the face masks and low filtration rates from the nasal filtration devices, this new nose respiratory filtration mask is invented.

### BRIEF SUMMARY OF THE INVENTION

This new nose respiratory filtration mask is a nasal filtration device that is composed of a whole master piece (for mounting, supporting, and sealing purposes) and a nanofiber filter that is mounted on the master piece outside the nostrils.

### ADVANTAGE OF THE NEW INVENTION

This invention is designed for respiratory protection of people breathing through their noses in smog or other particulate polluted atmospheres. This nose respiratory filtration mask has the following advantages:
1. The filters used in this invention are made from nanofibers which are only a few nanometers to several hundred nanometers in diameter, so the nanofiber filters can have submicron pore sizes to sieve out the PM2.5 while still maintaining high permeability.
2. This invention solves the air leakage problem that typically occurs with the usage of face masks, because our gourd-shaped nostril mounting and sealing tubes are highly elastic and flexible to contour to the user's nostril shape and seal against the nostril walls.
3. This invention solves the high air flow resistance problem that typically occurs when high efficiency filters are used in conventional nasal filter devices.
4. Compared to typical nostril filters, this new device will last much longer because of the increased filter area, and thus the filtration capacity.
5. It is light in weight, small in size, colored to match user's skin color, and placed under the user's nose so it is comfortable and aesthetically pleasing when wearing.

### BRIEF DESCRIPTION OF THE DRAWINGS

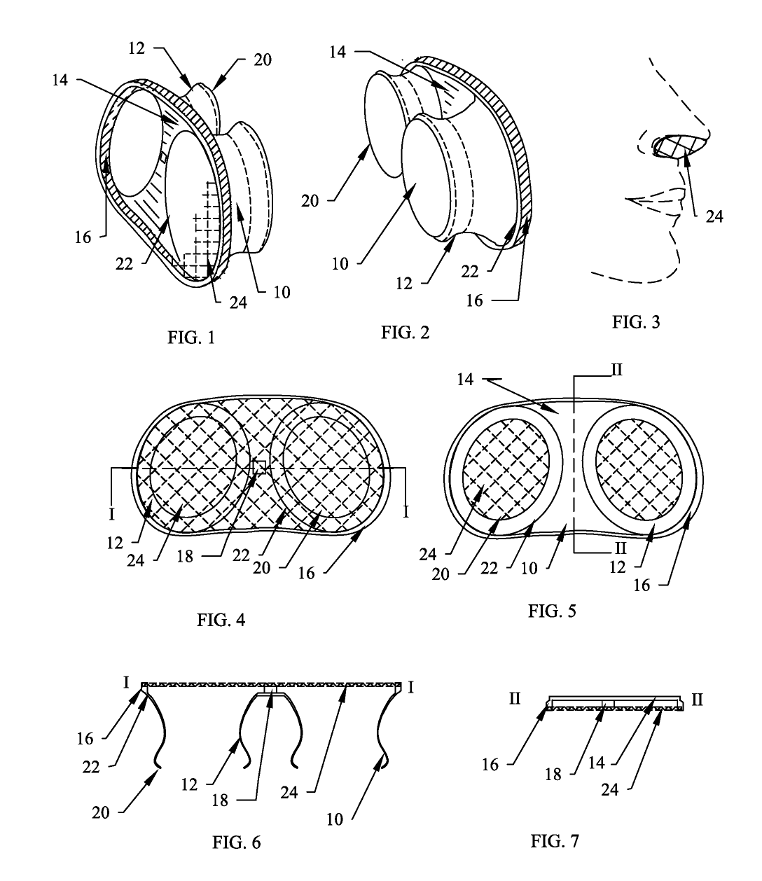

This nose respiratory filtration mask includes a master piece (10) that is used for the mask's nostril mounting, supporting, and sealing, and an exterior filter (24) that is affixed on the master piece. FIG. 1 is a perspective front view of the nose respiratory filtration mask (with the filtration net being partially torn off to see inside). FIG. 2 is a perspective rear view of the nose respiratory filtration mask. FIG. 3 is a perspective view of the nose respiratory filtration mask in use. FIG. 4 is a schematic front view of the mask. FIG. 5 is a schematic rear view of the mask. FIG. 6 is a schematic view of the mask's I-I cross section from FIG. 4. FIG. 7 is a schematic view of the mask's II-II cross section from FIG. 5.

### DETAILED DESCRIPTION

This nose respiratory filtration mask includes a master piece (10) for the mask's nostril sealing, supporting, and placement, and an exterior filter (24) attached to the master piece outside the nostrils. The master piece (10) is made of elastic and flexible materials, such as silicone rubbers. Its color can be transparent or skin colors. The shapes and sizes can be chosen to accommodate user's comfort needs.

The master piece (10) is one whole piece that includes the following components:

12: Two nostril mounting and sealing tubes. They are oval-shaped on lateral cross section views but each of the tubes is gourd-shaped on the axial direction. The flexible oval-shaped tubes (similar to the nipples used on baby feeding bottles) can easily fit in most users' nostrils and tightly seal against the nostril walls with some deformations. The neck of the gourd-shaped tube is designed to fit and maintain being booked on the nostril rims. The angled orientation of these two oval-shaped tubes is designed to match most users' nostril angles with minimum twist. Because the master piece is made of elastic and flexible silicone type of materials, it can perfectly deform and contour to the walls of the user's nostrils to prevent any air leakage.

14: The flat portion of the master piece (10). It is the flat portion of the master piece (10) between and around the two tubes (12). It is the base where the filter seat is placed along its perimeters. Because it is made of elastic and flexible silicone type of materials, it can bend to accommodate users' nasal and facial frame shapes.

16: Filter seat. It is an elevated belt that runs along the outer edge of 14. The filter (24) is tightly affixed on it to prevent any air leakage.

18: Support. This piece of cube provides additional support to prevent the filter from caving-in or blocking the air passages.

20: The projection line of oval-shaped inner rims of the 12.

22: The projection line of oval-shaped outer rims of the 12.

24: High efficiency nanofiber filters that are affixed on top of the filter seat (16). Nanofiber filters produced with polymers or other suitable materials are used for this invention. Filters with various pore sizes and various combinations of layer thicknesses can be designed based on the targeted pollutants and the efficiency needs. Specially designed and configured nanofiber filters may be provided for certain targeted pollutant filtrations.

Although various respiratory face masks and nasal filters are available in the market for protection of human breathing against smog or other particulate pollutants, this new invention has the advantages of both face mask's high particulate filtration efficiency and nasal filter's tight sealing as well aesthetic appearance.

The claims are:

1. A nose respiratory filtration mask comprising:
a flexible master piece; and
a nanofiber filter.

2. The filter in claim 1 is made from nanofibers.

3. The filter in claim 1 is placed outside the nostrils.

4. The filter in claim 1 is affixed on the outside seat ring of the master piece.

5. The filter in claim 1 can be specifically designed for targeted pollutants.

6. The master piece in claim 1 is for mounting, supporting, and sealing purposes.

7. The master piece in claim 1 is flexible to bend to fit users' facial shapes.

8. The master piece in claim 1 includes two gourd-shaped tubes.

9. The gourd-shaped tubes in claim 8 are flexible to contour to the shape of the user's nostrils with tight sealing.

10. The necks of the gourd-shaped tubes in claim 8 can fit and maintain position on the rims of user's nostrils.

11. The gourd-shaped tubes in claim 8 are oval-shaped tubes in cross section views.

12. The oval-shaped tubes in claim 11 can tightly fit into most users' nostrils and prevent any air leakage.

13. The orientation of the two oval-shaped tubes in claim 11 helps to accommodate and fit into users' nostrils.
